(19) United States
(12) Patent Application Publication
(10) Pub. No.: US 2005/0225537 A1
(43) Pub. Date: Oct. 13, 2005

(54) Keypad having -shaped button arrangement and method of inputting letters using the same

(76) Inventor: Min Ho Kim, Seoul (KR)

Correspondence Address: BRINKS HOFER GILSON & LIONE, P.O. BOX 10395, CHICAGO, IL, 60610, US

(21) Appl. No.: 11/093,454

(22) Filed: Mar. 30, 2005

(30) Foreign Application Priority Data
Apr. 12, 2004 (KR) 20-2004-0010101

(51) Int. Cl. G09G 5/00

(52) U.S. Cl. 345/168

(57) ABSTRACT

A keypad system is provided having a [symbol] -shaped button arrangement. The keypad system includes a plurality of buttons having consonant input buttons and vowel input buttons. Two or more consonants may be assigned to each consonant input button. The consonant input buttons may be arranged in a “ [symbol] ” shape. The two vowel input buttons may be assigned with two or three vowels. The vowel input buttons may be arranged in an inside area of the “ [symbol] ” shape.

### PRIORITY CLAIM

This application claims under 35 U.S.C. § 119 the benefit of the filing date of Apr. 12, 2004 of Korean Application No. 20-2004-0010101, the entire contents of which are incorporated herein by reference.

### BACKGROUND

1. Field of the Invention

The invention relates to a keypad for use with a phone. In particular, the invention relates to a keypad having a [symbol] -shaped button arrangement and a method of inputting letters using the keypad.

2. Description of the Related Art

FIG. 1 illustrates a mobile phone that includes a keypad 100 having a conventional button arrangement. The conventional button arrangement includes nine buttons that are sequentially arranged in a 3×3 matrix. The nine buttons may allow users to input alphabets QZ, ABC, DEF, GHI, JKL, MNO, PRS, TUV and WXY as shown in FIG. 1. Alphabets of other languages than English may appear on the same nine buttons. For example, Korean alphabets appear on the nine buttons along with English alphabets in FIG. 1. The keypad 100 further includes three buttons on the lower end portion thereof. Whenever each of the buttons is pressed, an alphabet letter assigned to the pressed button is selected.

FIG. 2 illustrates another mobile phone that includes a keypad 200 having eight button arrangements. Specifically, eighth buttons ABC, DEF, GHI, JKL, MNO, PQRS, TUV and WXYZ are arranged as shown in FIG. 2. Whenever each of the buttons is pressed, an alphabet letter assigned to the pressed button is selected.

In the keypads 100 and 200, the button arrangements follow the alphabetical order and do not differentiate consonants from vowels. When users try to input information, they may need to search the buttons assigned to vowels. Users may experience substantial inconvenience because users frequently need to search vowels for any sentence input. Furthermore, the button arrangements do not provide a convenient way to input a lowercase letter and a capital letter. Users are required to use separate input windows (input modes) with the keypads 100 and 200. For example, when users try to input a capital letter, for example, to start a sentence or input names, they first change to a capital letter input mode using a menu button and return to a lowercase input mode. Users often repeat this mode change many times. The mode changes may cause substantial inconvenience and input errors. Accordingly, there is a need of a keypad system that overcomes drawbacks of the conventional keypad system.

### SUMMARY OF THE INVENTION

The invention provides a keypad system including a consonant input button configured to be arranged in a “ [symbol] ” shape. The keypad system further includes a vowel input button configured to be arranged in an inside area of the “ [symbol] ” shape. The number of the vowel input button is smaller than the number of consonant input button.

The invention further provides a method of inputting letters using a keypad. The method includes selecting one consonant input button among a plurality of consonant input buttons arranged in a “ [symbol] ” shape and selecting one vowel input button among a plurality of vowel input buttons arranged in an inside area of the “ [symbol] ” shape. The method further includes operating the consonant input button and the vowel input button shorter, or longer than a predetermined time period for lowercase and capital letter inputs in a default input mode. The method also includes inputting a consonant and a vowel in a lowercase letter, or in a capital letter.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The above and other objects, features and advantages of the invention will be more clearly understood from the following detailed description taken in conjunction with the accompanying drawings, in which:

FIG. 1 illustrates a mobile phone that includes a keypad having a conventional button arrangement;

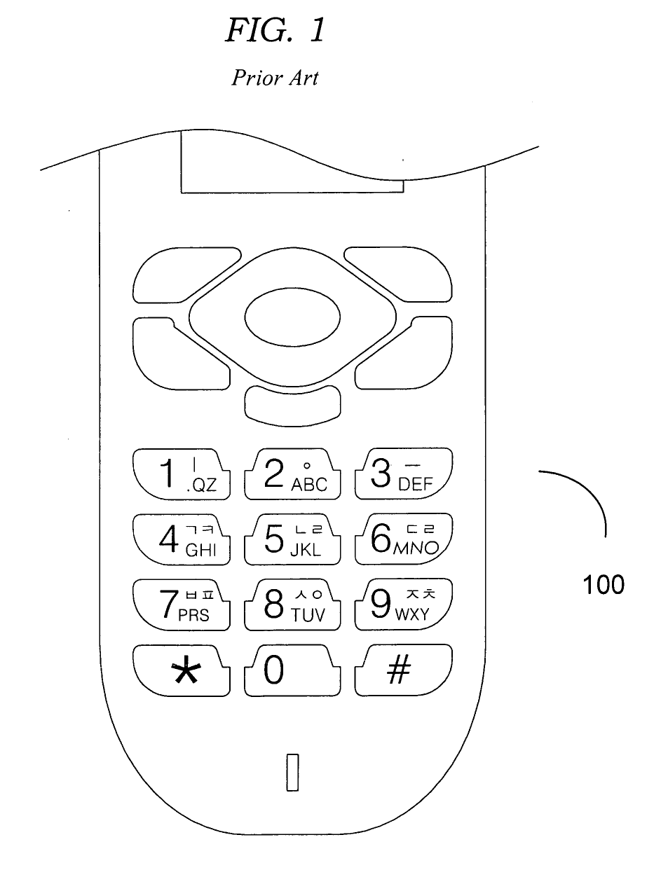

FIG. 2 illustrates a mobile phone that includes a keypad having another conventional button arrangement;

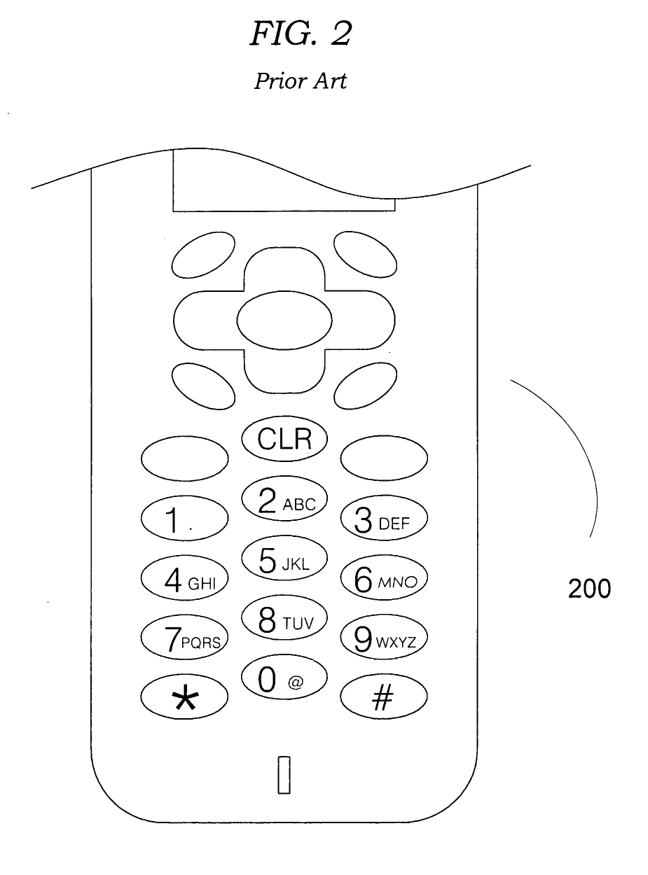

FIG. 3 illustrates an exemplary operation of an alphabet input using a keypad having a [symbol] -shaped button arrangement; and

FIG. 4 illustrates one embodiment of a keypad having a [symbol] -shaped button arrangement.

### DESCRIPTION OF THE PREFERRED EMBODIMENTS

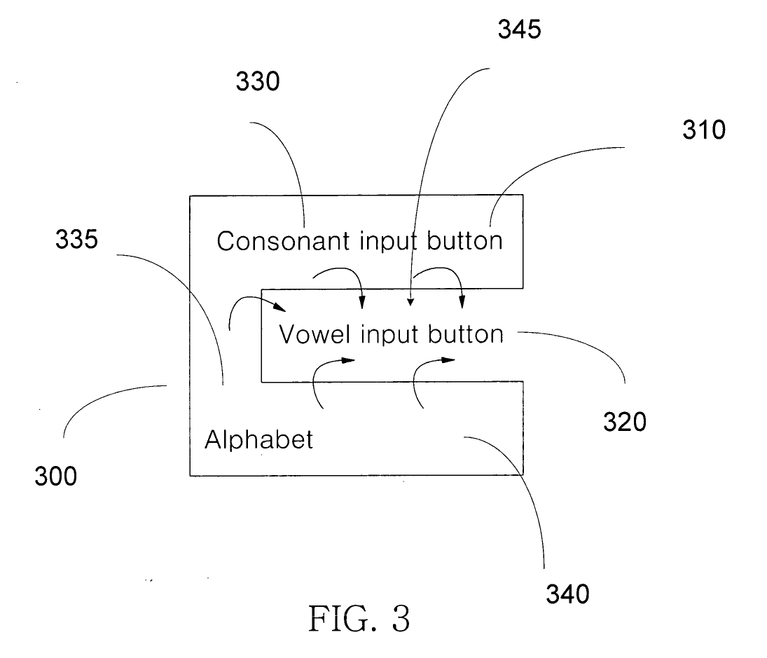

FIG. 3 illustrates an exemplary operation of an alphabet input using a keypad 300. The alphabet may be classified into consonants and vowels. Likewise, the keypad 300 may be divided to input consonants and vowels separately. Seven buttons 310 are used to input consonants. In particular, each button may be assigned with three consonants. In other embodiment, fewer or more consonants may be assigned to one button. The seven consonant input buttons 310 are arranged as shown in FIG. 3. Specifically, the consonant buttons 310 are arranged to be placed at a top portion 330, a left portion 335 and a bottom portion 340 of a square shape. A center portion 345 of the square shape may be left unoccupied by the consonant input buttons 310. Vowels input buttons 320 may be placed in the center portion 345 of the square shape. The arrangement of the consonant input button 310 may have a “ [symbol] ” shape. The letter, “ [symbol] ” is one of 26 Korean alphabets and may be pronounced as “diggeut.” The letter, “ [symbol] ” may be often used in Korea to indicate a particular shape such as incomplete enclosure due to an open right side or a surrounding wall with an open right side.

The arrangement of consonants input button in the “ [symbol] ” shaped area 330, 335 and 340 may follow the alphabetic order. The arrangement may be the alphabetic order in the clockwise direction. In other embodiment, the arrangement may be the counter-clockwise direction. Users may easily find location of consonant input buttons. When a user presses the seven consonant input buttons, consonants that are assigned to the pressed button are selected.

In the inside area 345 of the arrangement of the consonant input buttons, vowel input buttons are disposed. Vowels may be grouped and assigned to two vowel input buttons. In other embodiment, fewer or more input buttons may be assigned to vowels.

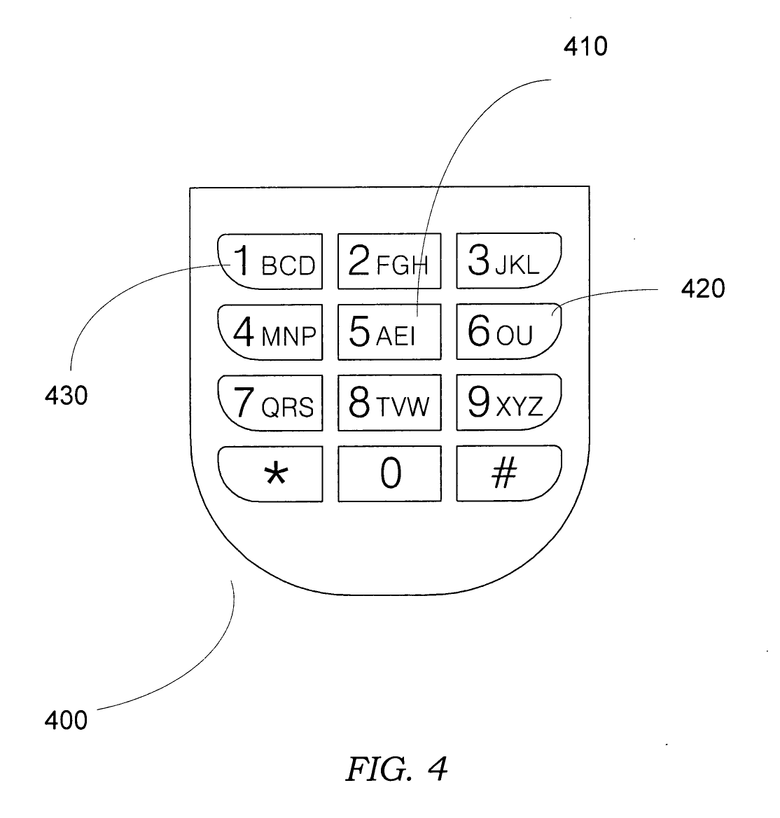

FIG. 4 illustrates one embodiment of a keypad having a [symbol] -shaped button arrangement. In the keypad 400, vowels may be grouped and assigned to two buttons. For example, a first button 410 is assigned with vowels, A, E and I, and a second button 420 is assigned with vowels, O and U. As shown in FIG. 4, the first and second buttons 410 and 420 may be disposed at the positions of buttons 5 and 6, respectively. In contrast, consonants are grouped and assigned to seven buttons. As shown in FIG. 4, each button is assigned with seven consonant groups, “BCD,” “FGH,” “JKL,” “MNP,” “QRS,” “TVW” and “XYZ.” In other embodiment, various other grouping of consonants may be possible. Seven input buttons having the consonant groups are disposed in the “ [symbol] ” shape. Further, seven input buttons correspond to number buttons 1, 2, 3, 4, 7, 8 and 9. As shown in FIG. 4, a number, “1” and consonants, B, C and D share a button 430.

During an input operation, users no longer need to search buttons for a vowel input. Users may focus on two vowel input buttons 410 and 420 and perform a vowel input with ease. When the seven consonant buttons are pressed selectively, desired consonants are inputted.

The keypad 400 may allow users to input a lowercase letter and a capital letter in a convenient way. Generally, a consonant and a vowel assigned to a letter input button are sequentially selected. While the keypad 400 is in a default input mode for letter inputs, the default input mode may allow users to input a consonant and a vowel in a lowercase letter by operating the consonant input button and the vowel input button shorter than a predetermined time period. Likewise, it may allow users to input a consonant and a vowel in a capital letter by operating the consonant input button and the vowel input button longer than a predetermined time period. To input a capital letter, users may operate the corresponding button longer than a predetermined time. No operation for changing an input mode is needed. For example, when users wants to input the letter, “a” using the button for “AEI,” they may input the letter, “a” for a short time. If users want to input a capital letter “A”, the letter “A” input may be inputted directly by operating the button for “AEI” longer than a predetermined time period. Users may be allowed to input a lowercase letter and a capital letter in a default mode without changing an input mode. In the capital letter input mode, users may be allowed to input a consonant and a vowel in a capital letter by operating the consonant input button and the vowel input button shorter than a predetermined time period only. Users also may input a consonant and a vowel in a lowercase letter by operating the consonant input button and the vowel input button longer than a predetermined time period.

Alternatively, or additionally, upon operation of a button, a lower case letter and a capital letter may appear sequentially. As noted above, a lower case letter appears when users operate a button briefly. As the operation of the button such as pressing the button lasts, a capital letter appears as an input and the lower case letter disappears. In other embodiment, an audible sound may be an output for a lowercase letter and/or a capital letter. Specifically, when a lowercase letter is an input as a result of a brief operation of the button, an audible sound is generated to notify users. A different audible sound may be generated as users keep the button operated. For example, the “beep” sound may be generated for any lowercase letter input. It is possible to assign a brief button operation to a capital letter input and an extended button operation to a lowercase letter input. Users may input a capital letter or a lowercase letter by pressing a specified button.

In another embodiment, a letter input may be performed as follows. When users incorrectly input a capital letter or a lowercase letter, they can change the inputted capital letter or lowercase letter into a lowercase letter or a capital letter by pressing a specified button. For example, when a capital letter “A” is inputted by mistake, the inputted letter “A” may be turned into a lowercase letter “a” upon operation of the specified button.

By using the operation of the buttons on the keypad 400, users may easily make lowercase letter inputs and capital letter inputs. This operation may substantially reduce inconvenience and input errors on the part of users.

An alphabet input operation of the keypad 400 will be described. By way of example only, users desire to input the sentence “I love you, Chul Soo” by using the keypad 400. Users first operate the button for “AEI” three times to reach vowel I. On a third press, users operate the button longer than a predetermined time period to input capital letter, “I.” Subsequently, users press a button assigned with a space function. The button may be one of three buttons for the number, “0,” * and #, which are displaced at the bottom of the keypad 400. In other embodiment, a separate space button may be provided. To input the verb, “love,” users may press the button for “JKL” three times shortly, the button for “OU” once shortly, the button for “TVW” twice shortly and the button for “AEI” twice shortly. After entering another space by using the space key or other keys, users may press the button for “XYZ” twice shortly, the button “OU” once shortly and twice shortly. Users may enter a comma by using one of three buttons for *, 0 and #, which is not used for entering the space. To input the name, “Chul Soo,” users may press the button for “BCD” twice and long on a second press, the button for “FGH” three times shortly, the button for “OU” twice shortly and the button for “JKL” three times shortly. Users again enter a space and press the button for “QRS” long on a third press, the button for “OU” once shortly and once again shortly. As a result, users may be able to input the sentence, “I love you, Chul Soo” with ease.

As described above, the keypad may provide a convenient button arrangement for consonant inputs and vowel inputs. The keypad further allows users to input a lowercase letter and a capital letter without changing input modes. Accordingly, users may be able to easily input even a long sentence with the compact keypad for use with devices such as a mobile phone.

The embodiments described above are explained in connection with mobile phones, but the invention is not limited thereto. The invention may be applicable to any apparatus and device requiring an input using a keypad, such as a digital TV remote controller and a computer remote controller. Furthermore, the invention is not limited to the English language and may be applicable to various other languages such as French, Greek, Korean (Hangul), Japanese (Katakana), or any other languages having consonants and vowels.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A keypad system comprising:
a consonant input button configured to be arranged in a “ [symbol] ” shape; and
a vowel input button configured to be arranged in an inside area of the “ [symbol] ” shape, wherein the number of the vowel input button is smaller than the number of consonant input button.

2. The keypad system according to claim 1, wherein the keypad system is mounted on a mobile phone having a display window.

3. The keypad system according to claim 2, wherein the keypad system is operable to input a character.

4. The keypad system according to claim 3, wherein the keypad system is operable to input an English alphabet.

5. The keypad system according to claim 1, wherein the keypad system comprises seven consonant input buttons and two vowel input buttons.

6. The keypad system according to claim 5, wherein a single button is assigned with three consonants.

7. The keypad system according to claim 5, wherein a single button is assigned with three vowels.

8. The keypad system according to claim 5, wherein a single button is assigned with two vowels.

9. The keypad system according to claim 6, wherein the single button is assigned with three consonants comprising a group of B, C and D, a group of F, G and H, a group of J, K and L, a group of M, N and P, a group of Q, R and S, a group of T, V and W, or, a group of X, Y and Z.

10. The keypad system according to claim 7, wherein the three vowels consist of A, E and I.

11. The keypad system according to claim 8, wherein the two vowels consist of O and U.

12. The keypad system according to claim 1, wherein the consonant input button and the vowel input button are operable to input a number.

13. A method of inputting letters using a keypad, comprising:
selecting a consonant input button among a plurality of consonant input buttons arranged in a “ [symbol] ” shape;
selecting a vowel input button among a plurality of vowel input buttons arranged in an inside area of the “ [symbol] ” shape; and
inputting a consonant and a vowel in a lowercase letter by operating the consonant input button and the vowel input button shorter than a predetermined time period.

14. The method of claim 13, further comprising:
inputting a consonant and a vowel in a capital letter by operating the consonant input button and the vowel input button longer than the predetermined time period.

15. The method of claim 13, further comprising:
displaying the consonant and the vowel in the lowercase letter in response to the operation of the consonant input button and the vowel input button.

16. The method of claim 14, further comprising:
displaying the consonant and the vowel in the capital letter in response to the operation of the consonant input button and the vowel input button.

17. The method of claim 15, further comprising:
changing the lowercase letter to the capital letter by operating a specified button in the keypad.

18. The method of claim 16, further comprising:
changing the capital letter to a lowercase letter by operating a specified button in the keypad.

19. The method of claim 13, further comprising:
generating a first audible sound in response to the operation of one of the consonant input button and the vowel input button.

20. The method of claim 14, further comprising:
generating a second audible sound in response to the longer operation of one of the consonant input button and the vowel input button.

21. A method of inputting letters using a keypad, comprising:
selecting a consonant input button among a plurality of consonant input buttons arranged in a “D” shape;
selecting a vowel input button among a plurality of vowel input buttons arranged in an inside area of the “ [symbol] ” shape;
in a capital input mode, inputting a consonant and a vowel in a capital letter by operating the consonant input button and the vowel input button shorter than a predetermined time period;
inputting a consonant and a vowel in a lowercase letter by operating the consonant input button and the vowel input button longer than the predetermined time period;
changing a first capital letter to a first lowercase letter by operating a button in the keypad upon the input and display of the first capital letter; and
changing a second lowercase letter to a second capital letter by operating the button in the keypad upon the input and display of the second lowercase letter.
